(19) United States
(12) Patent Application Publication
(10) Pub. No.: US 2026/0031650 A1
(43) Pub. Date: Jan. 29, 2026

(54) AUTOMATIC TRANSFER SWITCH CONTROL AND POWER DISTRIBUTION SYSTEM

(71) Applicant: TRYSTAR, LLC, Faribault, MN (US)

(72) Inventors: Jack Mills Zimmerman, Faribault, MN (US); Steven R. Heimerman, Faribault, MN (US); Jesse Daniel Walderon, Owatonna, MN (US)

(21) Appl. No.: 19/280,774

(22) Filed: Jul. 25, 2025

Related U.S. Application Data
(60) Provisional application No. 63/676,146, filed on Jul. 26, 2024.

(51) Int. Cl. H02J 9/06; H01H 71/10; H02J 3/00

(52) U.S. Cl. CPC H02J 9/068; H01H 71/1045; H02J 3/007

(57) ABSTRACT

An automatic transfer switch for use with an electrical power distribution system to control the delivery of power to a load during a switching event from a primary power source to a secondary power source. A high-amperage automatic transfer switch (HA-ATS) according to embodiments of this disclosure can have a control circuit that is powered by either or both of the primary and secondary power sources. In some cases, a HA-ATS according to this disclosure does not have a separate redundant power source (e.g., a generator, battery, UPS, capacitor bank, etc.) to provide power to the control circuit of the HA-ATS. In some cases, a HA-ATS according to this disclosure can be configured to be agnostic to characteristics of an input power source while providing an appropriate power signal to the control circuit of the HA-ATS.

### CROSS-REFERENCE TO RELATED APPLICATIONS

This application claims the benefit of U.S. Provisional Application No. 63/676,146, filed Jul. 26, 2024, the entire contents of which are incorporated herein by reference.

### TECHNICAL FIELD

This disclosure relates generally to the field of electrical technology and, more particularly, to devices, systems, and methods for switching an electrical system between a primary power source and a secondary power source.

### BACKGROUND

Electrical loads, such as buildings, are typically powered by an electrical grid operated by an electrical utility. While the electrical grid can usually provide electricity to the electrical loads, disruptions such as severe weather, equipment failures, maintenance issues, etc., can cause the electrical grid to become unable to provide electricity to the electrical loads. In these instances, backup power can be used to provide power to the electrical loads. Backup power can come in many forms such as alternate electrical utility connections, battery banks, and generators.

Switching an electrical load between a primary power source (e.g., a utility connection) and a secondary power source is typically performed by using a transfer switch. The transfer switch can switch the electrical connection of the load from being powered by the primary power source to the secondary power source, either manually or automatically. Simple automatic transfer switches can switch between primary and secondary power sources without requiring a separate source of power. However, automatic transfer switches and/or controllers connected thereto that have advanced features (such as voltage monitoring) require a power source separate from the primary and secondary power sources to enable such features.

In the case of control systems that are designed to respond to conditions of utility/line power failure, for example, providing carry-over power provides stability of the system and ensures the ability of the controller to output logic to control the system. In many examples in the market, uninterruptable power supplies (“UPS”) and other forms of batteries are typically used for this purpose.

Forms of redundant power involving batteries require certain maintenance and temperature considerations, which can limit suitable applications and environments and can require maintenance that might be difficult to perform and inconvenient for the application. Using a generator battery as a redundant power source can provide challenges, as the status of said battery is unknown during the use of a temporary generator through the camlock connections. Thus, a solution is needed that has wide range of operating temperatures, is reliable (little need for serviceability), is robust (can perform under reasonably unforeseeable conditions), and can use both lines of power after assuring they are of sufficient quality.

### SUMMARY

High-amperage automatic transfer switches (HA-ATS) designed for use with power distribution systems can solve such problems by allowing the control system to be powered by one or both lines (e.g., primary and/or secondary power sources). This eliminates the need to use a generator battery as a redundant power source or to add a UPS with its noted limitations (e.g., difficult and/or inconvenient maintenance requirements and/or temperature constraints and considerations). This power distribution system can be made up of relay logic, and thus can be made to be robust with respect to a range of operating conditions and can be adapted to many different voltage and frequency requirements by the simple swap of contactor coil and contact ratings, for example.

In some examples, a power distribution system designed for use with an automatic transfer switch, such as those described herein, can additionally include a feature that enables the system to be “agnostic” to the characteristics of the power source. Such a feature may be desirable, for example, in applications where either or both power sources (primary and secondary) may be a temporary source of power or a local source of power (e.g., at an outdoor event, for example, where the automatic transfer switch is “portable” and can be brought to a location having unknown, unconfirmed, or variable power characteristics, possibly on an “as-needed” basis). Such a feature can be configured to detect or sense an aspect of the input power source, such as the input voltage (e.g., 600V, 480V, 208V three-phase power) and make an adjustment via the use of switches and/or transformers to provide an appropriate power signal for controlling the operation of the automatic transfer switch. Such a feature can help avoid a failure of and/or damage to the automatic transfer switch that might result, for example, if an operator erroneously selected the “wrong” input voltage characteristic manually.

In some examples, a power distribution system is described, capable of automatically switching between two sources of power to supply power to a load. In some cases, the power distribution system is configured to switch between connecting or coupling a primary electrical power source and a secondary electrical power source to power an electrical load. The power distribution system can include a primary electrical power source and a secondary electrical power source. The secondary electrical power source can include a normally-closed contact that is configured to, when closed, enable the secondary electrical power source to provide electrical power. In some cases, the normally-closed contact may be configured to, when closed, cause the secondary electrical power source to start up.

The power distribution system can further include a transfer switch connected to the primary electrical power source, to the secondary electrical power source, and to the electrical load. The transfer switch can be configured to electrically connect the electrical load to either the primary electrical power source or the secondary electrical power source. The power distribution system can further include a controller in electric communication with the transfer switch and configured to control the transfer switch in order to control whether electrical power is directed to the electrical load from the primary electrical power source or the secondary electrical power source. The power distribution system can further include a controller power supply circuit in communication with the primary electrical power source, the secondary electrical power source, and the controller. The controller power supply circuit can be configured to provide electrical power to the controller using electrical power from at least one of the primary electrical power source and the secondary electrical power source.

In some examples, the controller and the controller power supply circuit are configured such that, if electrical power from the primary electrical power source is available, then the controller power supply circuit supplies power to the controller using electrical power from the primary electrical power source, the controller provides electrical power to the secondary electrical power source to hold open the normally-closed contact so that the secondary electrical power source does not provide power to the electrical load, and the controller controls the transfer switch to provide electrical power to the electrical load from the primary electrical power source.

In some examples, a switching system is described for automatically switching between a primary electrical power source and a secondary electrical power source to power an electrical load. The switching system may include a transfer switch connected to the primary electrical power source, the secondary electrical power source, and the electrical load. The transfer switch can be configured to electrically connect the electrical load to either the primary electrical power source or to the secondary electrical power source. For example, upon a loss of power in the primary electrical power source, the transfer switch can operate to switch to electrically connect the electrical load to the secondary electrical power source rather than the primary electrical power source.

The switching system can include a controller in communication with the transfer switch. The controller can be configured to control the transfer switch in order to control whether electrical power is directed to the electrical load from the primary electrical power source or the secondary electrical power source. The switching system can include a controller power supply circuit in communication with the primary electrical power source, the secondary electrical power source, and the controller. The controller power supply circuit can be configured to provide electrical power to the controller using power from at least one of the primary electrical power source and the secondary electrical power source.

In some cases, the controller and the controller power supply circuit are configured such that, if electrical power from the primary electrical power source is available, then the controller power supply circuit powers the controller using electrical power from the primary electrical power source, the controller provides power to the secondary electrical power source to hold open a normally-closed contact associated with the secondary electrical power source so that the secondary electrical power source does not operate, and the controller controls the transfer switch to provide electrical power to the electrical load from the primary electrical power source.

Exemplary embodiments are described herein for a high-amperage automatic transfer switch control and power distribution system. The details of one or more examples are set forth in the accompanying drawings and the description below. Other features, objects, and advantages will be apparent from the description and drawings.

### BRIEF DESCRIPTION OF DRAWINGS

The following drawings are illustrative of particular embodiments of the present invention and therefore do not limit the scope of the invention. The drawings are intended for use in conjunction with the explanations in the following description. Embodiments of the invention will hereinafter be described in conjunction with the appended drawings, wherein like numerals denote like elements.

FIG. 1A is a schematic view of an exemplary automatic transfer switch and power distribution system according to an aspect of the present disclosure;

FIG. 1B is a schematic view of an exemplary controller power supply circuit configuration according to an aspect of the present disclosure;

FIG. 2 is a schematic view of an exemplary switching network with a monitoring relay according to an aspect of the present disclosure;

FIG. 3 is an exemplary process flow diagram illustrating system operation, including controlling power distribution to the controller and to a load according to an aspect of the present disclosure;

FIG. 4 is a flow chart of an example operation of an automatic transfer switch and power supply system according to an aspect of the present disclosure;

FIG. 5 is a flow chart of an example operation of an automatic transfer switch and power supply system according to an aspect of the present disclosure; and

FIG. 6 is a schematic view of an example voltage override system for an automatic transfer switch according to an aspect of the present disclosure.

### DETAILED DESCRIPTION

The following detailed description is exemplary in nature and provides some practical illustrations and examples. Those skilled in the art will recognize that many of the noted examples have a variety of suitable alternatives. A number of various exemplary transfer switches and associated controllers and controller power supply circuits are disclosed herein using the description provided as follows in addition to the accompanying drawings. Each of the embodiments disclosed herein can be employed independently or in combination with one or more (e.g., all) of the other embodiments disclosed herein.

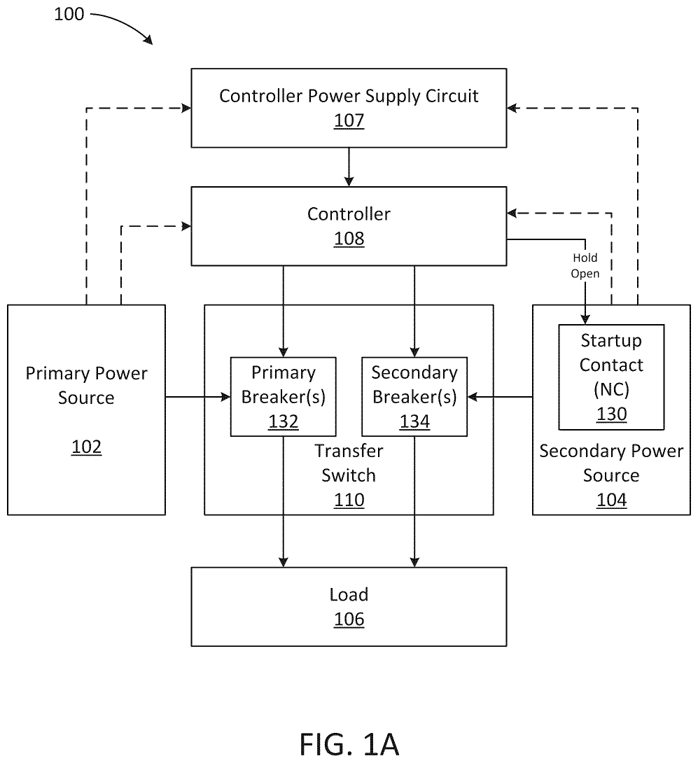

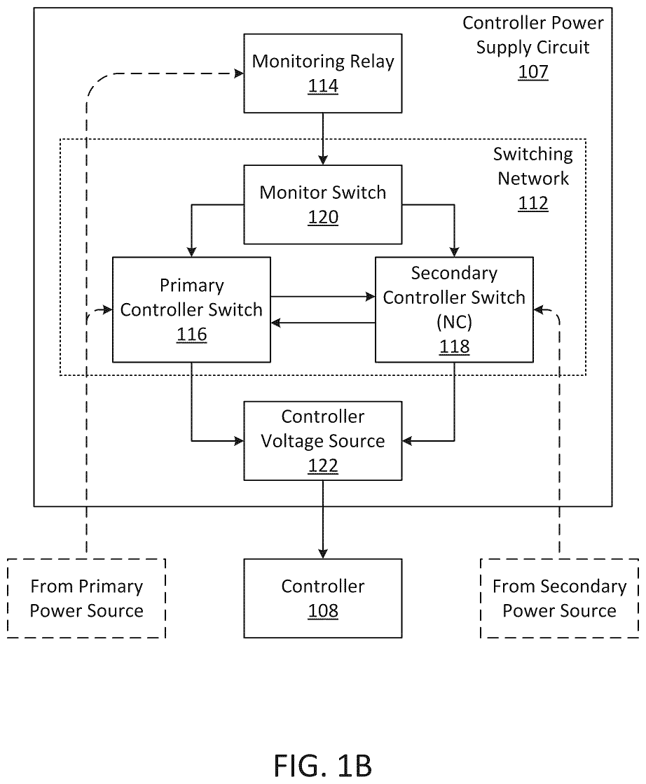

FIG. 1A is a schematic view of an example automatic transfer switch and power distribution system 100 according to an aspect of the present disclosure. The system 100 includes a primary power source 102, a secondary power source 104, a load 106, and a controller 108 configured to control a transfer switch 110. Primary power source 102 and secondary power source 104 can include primary and secondary electrical power sources, respectively, configured to provide electrical power. Similarly, load 106 can include an electrical load. In such cases, the transfer switch 110 enables the load 106 to be electrically connected to the primary power source 102 or the secondary power source 104. The controller 108 can control the transfer switch 110 to switch between electrically connecting the primary power source 102 to the load 106 and electrically connecting the secondary power source 104 to the load 106. The controller 108 is configured to be powered by either or both of the primary power source 102 and the secondary power source 104. In the illustrated example, a controller power supply circuit 107 receives power from both the primary power source 102 and the secondary power source 104 and provides power to the controller 108.

In the example of FIG. 1A, the transfer switch 110 comprises a plurality of circuit breakers divided into two sets of circuit breakers: a set of primary power source breakers 132, and a set of secondary power source breakers 134. Each set of circuit breakers can comprise one or more circuit breakers. For example, in some example three-phase systems, each set of breakers (the set of primary power source breakers 132 and the set of secondary power source breakers 134) includes a single three-phase circuit breaker. Such configurations can be arranged to comply with NFPA 70. Other configurations are also possible. For instance, in other example three-phase systems, each set of circuit breakers can comprise three separate circuit breakers, one circuit breaker for each phase. In embodiments where each set of circuit breakers includes more than one circuit breaker, the circuit breakers in a set can be interlinked such that if one of the circuit breakers trips or is disconnected, then the other circuit breaker(s) in the set are also tripped or disconnected. In FIG. 1A, the primary power source breakers 132 can connect/disconnect the primary power source 102 to the load 106 and the secondary power source breakers 134 can connect/disconnect the secondary power source 104 to the load 106. The controller 108 can control the circuit breakers 132, 134 in order to control operation of the transfer switch 110 and dictate the source of electrical power being supplied to the load 106. Additionally, as one having ordinary skill in the art will appreciate, the plurality of breakers in the transfer switch 110 can operate in either a break-before-make or a make-before-break configuration. In some examples, primary power source breaker(s) 132 and/or secondary power source breaker(s) 134 can operate using current values up to 5000 A or more. Various breaker designs and options can be used, including various off-the-shelf breakers.

The transfer switch 110 can also include additional components that enable additional functionality such as the ability to be monitored and/or controlled (e.g., via a controller). For example, one or more breakers of the transfer switch can include one or more of a spring-charging motor, a shunt trip, a close coil, trip status auxiliary (e.g., a bell alarm), a mechanical interlock, a breaker status auxiliary connection, or an interlock auxiliary connection. The spring-charging motor can be used to automatically charge a circuit breaker's closing spring such that the breaker is in a state to close upon receiving a signal to close (e.g., from the controller, from a close coil). The shunt trip can open a circuit breaker almost instantly when energized, such as upon receiving a signal to open (e.g., from the controller). The close coil can close the circuit breaker when energized, such as upon receiving a signal to close (e.g., from a controller). The trip status auxiliary can indicate that a circuit breaker has tripped (e.g., via an electronic signal). The mechanical interlock can physically prevent a circuit breaker connected to the primary power source from being closed at the same time as a circuit breaker connected to the secondary power source, thereby preventing both primary and secondary power sources from being simultaneously connected to a load. In some cases, the mechanical interlock can be a backup to an electronic interlock that performs the same function electronically rather than physically. The breaker status auxiliary connection can indicate the current status, either open or closed, to a connected device such as a controller. The interlock auxiliary connection can prevent the close coil from being activated (e.g., via a controller) based upon the interlocked breaker status.

While the transfer switch 110 is described as using circuit breakers, the transfer switch can use other means of a controllable connection, such as a switch or switches controllable by the controller 108. For example, if the system is a single-phase system, then the switch can be a single-pole double-throw switch that enables connection of the load 106 to either the primary power source 102 or the secondary power source 104. However, it may be advantageous for the transfer switch 110 to use circuit breakers in some applications, since circuit breakers can be rated for high current/high amperage applications (e.g., up to 5000 A) relative to switches. Circuit breakers can also more easily satisfy electrical code requirements, and can enable a direct connection to a utility power source (e.g., primary and/or secondary power source(s) 102, 104). In some examples, breakers can be service-entrance-rated. Non-breaker-based transfer switches may otherwise require a separate breaker in line between the utility and the transfer switch, which may require extra components and expense compared to a breaker-based transfer switch. A person having ordinary skill in the art will appreciate that other transfer switch mechanisms can be used, and that this disclosure is not limited to the particular example mechanisms described herein.

Continuing with FIG. 1A, the system 100 includes controller power supply circuit 107, which can be configured to control whether the controller 108 receives power from the primary power source 102 or the secondary power source 104. The controller power supply circuit 107 can include one or more switches (e.g., relays) that enable the controller 108 to conditionally be powered from the primary power source 102 or the secondary power source 104. In some embodiments, the controller power supply circuit 107 includes one or more meters configured to determine and/or act in response to one or more properties of the power received from the primary power source 102 and/or the secondary power source 104. For instance, in some examples, the controller power supply circuit 107 includes a monitoring relay configured to receive power from one or both of the primary power source 102 and the secondary power source 104, and control which of the primary and second power sources is used to power to the controller 108. In some examples, the controller power supply circuit 107 defaults to providing power to the controller 108 using the primary power source 102 unless power from the primary power source 102 is unavailable, insufficient, or otherwise undesirable (e.g., based on one or more measurements and/or determinations performable by the controller power supply circuit 107). In some such examples, the controller power supply circuit 107 only monitors the power from the primary power source 102 and only causes the secondary power source 104 to power the controller 108 when the power from the primary power source 102 is deemed to be insufficient in some way (e.g., not present, of low quality, etc.).

The primary power source 102 and the secondary power source 104 are separate power sources and can comprise various types of power sources. For example, the primary power source 102 can comprise a utility/grid connection, a generator or generators, a battery bank, and/or other power sources. Similarly, the secondary power source 104 can comprise a utility/grid connection, a generator or generators, a battery bank, and/or other power sources. The secondary power source 104 is a separate power source from the primary power source 102, but it can be of the same type of power source as the primary power source 102, or of a different type. For instance, the primary power source 102 can include a primary generator and the second power source 104 can include a secondary generator. In another example, the primary power source 102 can comprise a first utility/grid connection and the secondary power source 104 can comprise a second utility/grid connection. In such an example, the first utility/grid connection and the second utility/grid connection are independent from each other such that if one utility cannot provide power, then the other utility continues to provide power.

As described elsewhere herein, in various examples, the controller 108 can be configured to receive power from either or both of the primary power source 102 and the secondary power source 104. In some examples, the system 100 favors the primary power source 102, and when sufficient power is available from the primary power source 102, the controller 108 is powered by the primary power source 102 and controls the transfer switch 110 to provide power from the primary power source 102 to the load 106 (e.g., by maintaining primary breaker(s) 132 in a closed, conducting state and secondary breaker(s) 134 in an open, non-conducting state). In some embodiments, when power from the primary power source 102 becomes unavailable (e.g., due to a power outage on utility lines, etc.), or is determined to be insufficient, the controller 108 is powered by the secondary power source 104 and controls the transfer switch 110 to provide power from the secondary power source 104 to the load 106 (e.g., by maintaining primary breaker(s) 132 in an open, non-conducting state and secondary breaker(s) 134 in a closed, conducting state).

In some embodiments, the system 100 is configured so that, when the primary power source 102 fails (e.g., loses power), the system 100 automatically switches over to operating using the secondary power source 104. In some such examples, a normally-closed contact 130 enables operation of the secondary power source 104, for example to ultimately power the controller 108 and/or the load 106. In an example embodiment, when the primary power source 102 provides power to the controller 108, the controller is configured to hold open the normally-closed contact 130 to prevent power from the secondary power source 104 from powering the controller 108 and/or providing power to the secondary breaker(s) 134. When the primary power source 102 fails and the controller 108 loses power from the primary power source 102, the controller 108 stops holding the normally-closed contact 130 in an open position (e.g., the contact 130 moves from an open position to a closed position), and the closing of contact 130 causes power to be applied from the secondary power source 104 to the controller 108.

In some examples where the secondary power source 104 comprises one or more generators, upon the primary power source 102 failing (e.g., no longer able to provide power), the system 100 can cause the generator(s) of the secondary power source 104 to start up. For instance, a normally-closed contact 130 associated with the secondary power source 104 can be configured such that, when the contact 130 is closed, the generator starts and begins providing power. In some embodiments, the normally-closed contact 130 is an auto-start contact for a generator such that, when the contact 130 closes (e.g., upon the controller 108 losing power from the primary power source 102), the generator is configured to automatically start.

In some examples, the controller 108, when powered by primary power source 102, holds open the normally-closed contact 130 so that the generator does not start up or run. However, if the primary power source 102 fails and the controller 108 no longer receives power from the primary power source 102, then the controller 108 no longer holds open the normally-closed contact 130 and the contact 130 is allowed to close. The closing of contact 130 passively causes the generator to start up and provide power to the controller 108. Such passive activation of the generator can allow for the secondary power source 104 to be activated and to subsequently provide power to the controller 108 without need for a battery or UPS backup system.

In some embodiments, initiating the secondary power source 104 (e.g., a generator) to start up in response to the normally-closed contact 130 closing after the controller 108 loses power from the primary power source 102 can occur on the order of 75-200 milliseconds following a loss of power, for example. However, the time it takes for a generator to fully power up after being initiated (e.g., after the normally-closed contact 130 closes) can depend on the properties of the generator itself, which may be an off-the-shelf, commercially available generator.

Accordingly, in cases where the secondary power source 104 comprises one or more generators, the generator(s) can take some amount of time (e.g., a finite amount of time) for the generator(s) to begin providing power after being activated. The controller 108 may be unpowered during this time as the controller 108 no longer receives power from the primary power source 102, and the secondary power source 104 does not provide useable power for a period of time (e.g., a generator startup time).

FIG. 1B shows an exemplary configuration for a controller power supply circuit 107. As illustrated, the controller power supply circuit 107 includes a monitoring relay 114, a switching network 112, and a controller voltage source 122. The controller voltage source 122 can be configured to receive power from either the primary power source 102 or the secondary power source 104 and output a voltage suitable for the controller 108. In various examples, the controller voltage source 122 comprises a transformer configured to receive a first AC voltage from the primary power source 102 or the secondary power source 104, and output a second AC voltage (e.g., a lower voltage than the first AC voltage). In an example embodiment, a transformer is configured to receive 480 VAC (e.g., three-phase, 277 VAC/phase) and output 240 VAC. The controller voltage source 122 can further include a power supply unit configured to receive an AC input from the transformer (e.g., 240 VAC) and output a DC voltage (e.g., 24 VDC), which can be provided to the controller 108.

In some examples, the monitoring relay 114 can be configured to monitor the voltage available from one or both of the primary power source 102 and the secondary power source 104 and causes the switching network 112 to control whether power to be output to the controller 108 is provided by the primary power source 102 or the secondary power source 104.

In the illustrated example, the switching network 112 includes a primary controller switch 116 and a secondary controller switch 118. The primary controller switch 116 can electrically connect the controller voltage source 122 with the primary power source 102 such that the controller voltage source 122 receives and utilizes power from the primary power source 102. Similarly, the secondary controller switch 118 can electrically connect the controller voltage source 122 with the secondary power source 104 such that the controller voltage source 122 receives and utilizes power from the secondary power source 104. In some examples, the primary controller switch 116 and the secondary controller switch 118 can be co-located in an enclosure that is electrically connected to the controller 108 and to the primary and secondary power sources 102, 104.

In an example implementation, under normal operating conditions, the primary power source 102 provides power to the controller voltage source 122 through the primary controller switch 116. The controller voltage source 122 can provide power to the controller 108, which can control the transfer switch 110 to switch between connecting the load 106 to the primary power source 102 or the secondary power source 104.

During normal operating conditions, to prevent the secondary power source 104 from providing power to the controller voltage source 122 simultaneously with the primary power source 102, the secondary controller switch 118 is prevented from being closed (thereby being maintained in an electrically non-conducting state) while the primary controller switch 116 is closed (conducting). The secondary controller switch 118 is labeled with “NC,” indicating that the secondary controller switch 118 is configured to be a “normally-closed” (e.g., electrically conducting) switch. Accordingly, to prevent the secondary controller switch 118 from being in its normally closed position, the secondary controller switch 118 is maintained in an open position (not conducting) when the primary controller switch 116 is closed (conducting). The primary power source 102 can provide power to the secondary controller switch 118 (e.g., via the primary controller switch 116) to maintain the secondary controller switch 118 in an open position. Additionally or alternatively, in some embodiments, to prevent the primary power source 102 and the secondary power source 104 from connecting to the controller voltage source 122 simultaneously, the primary controller switch 116 and the secondary controller switch 118 can be interlinked. Accordingly, when the secondary controller switch 118 switches from an open position to a closed position, the primary controller switch 116 switches from a closed position to an open position. The link between the primary controller switch 116 and the secondary controller switch 118 is illustrated by the arrows between them. As one having ordinary skill in the art will appreciate, the link can be mechanical, electrical, and/or electromechanical in nature.

In abnormal operating conditions, e.g., when the primary power source 102 drops out or is otherwise no longer able to provide power to the controller 108, the controller 108 cannot control the transfer switch 110 to connect the load 106 to the secondary power source 104 unless it receives power. While some configurations may use a UPS or battery backup to provide temporary power to the controller 108 when primary power to the controller is lost, these configurations can require additional maintenance. For instance, UPS and battery backups can be susceptible to damage, have additional environmental constraints (e.g., temperature limits), require ongoing maintenance, and require additional maintenance including replacement of batteries.

In the illustrated example, the controller 108 is not connected to a UPS or battery backup. Instead, the switching network 112 can operate to enable the secondary power source 104 to provide power to the controller 108. An advantage of the switching network 112 is that the switching network 112 can cause one or more switching actions to occur even if not powered by a power source. For instance, if the primary power source 102 provides power to the secondary controller switch 118 to maintain the normally-closed secondary controller switch 118 in an open position, when the primary power source 102 stops providing power, the normally-closed secondary control switch 118 automatically closes (e.g., moves to its normally-closed position) and electrically connects the secondary power source 104 to the controller voltage source 122 to power the controller 108. Thus, even when the controller 108 loses power from the primary power source 102 and before it receives power from the secondary power source 104, the switching network 112 (e.g., by way of the normally-closed secondary control switch 118) can cause one or more switching actions to occur despite the momentary lack of power.

The controller power supply circuit 107 can include a monitoring relay 114 and a corresponding monitor switch 120. The monitoring relay 114 can monitor one or more parameters, such as one or more voltages (e.g., one or more true root mean square, TRMS, voltages), frequency information, and/or phase balance. In some examples, the monitoring relay 114 can also determine whether a voltage, frequency, or phase balance is within an acceptable range. As shown in the example of FIG. 1B, the monitoring relay 114 is in communication with the primary power source 102 and can monitor the voltage, or voltages in three-phase systems, of the primary power source 102. The monitoring relay 114 can detect a presence of voltage corresponding with the primary power source 102, measure a voltage corresponding with a primary power source 102, and determine whether the voltage corresponding with the primary power source 102 is within an acceptable range.

In FIG. 1B, the monitoring relay 114 is in communication with the monitor switch 120, which is part of the switching network 112. The monitor switch 120 is also in communication with both the primary controller switch 116 and the secondary controller switch 118. In some examples, the primary controller switch 116 does not connect directly to the primary power source 102, but connects to the primary power source 102 through the monitor switch 120. Similarly, in some examples, the secondary controller switch 118 does not connect directly to the secondary power source 104, but rather, connects to the secondary power source 104 through the monitor switch 120.

In operation, the monitoring relay 114 can cause the monitor switch 120 to dictate whether the primary power source or the secondary power source powers the controller voltage source 122. For example, in some embodiments, the monitor switch 120 can be configured to either be in an open (e.g., disconnected) configuration or a closed (e.g., connected) configuration. In some examples, the monitoring relay 114 completes a circuit that energizes the monitor switch 120, which can be a relay, to cause the monitor switch 120 to operate. The monitoring relay 114 can cause the monitor switch 120 to operate based on results of the various functions the monitoring relay 114 performs. For example, the monitoring relay 114 can open or close the monitor switch 120 based on one or more of the presence/absence of voltage corresponding with the primary power source, the measured voltage corresponding to the primary power source, including whether the voltage is within an acceptable range, and/or time-related aspects of the above (e.g., amount of time of the presence of a voltage corresponding with the primary power source).

For instance, in some embodiments, the monitoring relay 114 and monitor switch 120 operate together to determine if the power from primary power source is present and/or suitable to provide power to the controller 108 and/or the load 106, and, if so, then the monitor switch 120 causes the primary controller switch 116 to power the controller voltage source 122, which powers the controller 108 using power from the primary power source. If not, then the monitor switch 120 can cause the secondary controller switch 118 to couple the controller voltage source 122 to the secondary power source, which can power the controller 108 once it is producing power.

In some examples, though, the monitoring relay 114 only performs monitoring functions associated with one or the other of the primary power source and the secondary power source. A person having ordinary skill in the art will appreciate that the monitoring relay 114 can be configured for single-phase and/or three-phase voltages, that more than one monitoring relay can be used (e.g., one per power source), and that this disclosure is not limited to the example connections of the monitoring relay described herein. In some examples, the monitoring relay 114 can additionally or alternatively detect a presence of voltage corresponding with the secondary power source, measure a voltage corresponding with the secondary power source, and determine whether the voltage corresponding with the secondary power source is within an acceptable range.

In some examples, in addition to or instead of the monitoring relay 114, the system 100 can include one or more other meters/monitors that cause the monitor switch 120 to actuate or operate (e.g., open or close). For instance, in some examples, the system 100 includes one or more voltage meters, current meters, phase meters, power quality meters, and the like. Moreover, the one or more meters/monitors can be single-phase, three-phase, or the like. As with the monitoring relay 114 described elsewhere herein, the one or more meters/monitors can be configured to operate/actuate the monitor switch 120 based on the results/measurements of the one or more meters/monitors. For example, the one or more meters/monitors can be configured to measure a power factor and operate the monitor switch 120 based on the measured power factor.

In example operations of the illustrated embodiment of FIG. 1B, the monitoring relay 114 and the monitor switch 120 work to determine which power source provides power to the controller voltage source 122 to power the controller 108. In some examples, the monitoring relay 114 and/or monitor switch 120 are configured to monitor the presence of voltage at the primary power source, the presence of voltage at the secondary power source, and one or more metered values of the voltage available at the primary power source.

In a first scenario, the monitoring relay 114 can detect a presence of voltage of the primary power source 102, a lack of voltage of the secondary power source 104, and detect that the voltage of the primary power source 102 is within an acceptable range. The monitor switch 120 can operate to provide power from the primary power source to the controller voltage source 122 via the primary controller switch 116.

In a second scenario, the monitoring relay 114 can detect a presence of voltage of the primary power source 102, a presence of voltage of the secondary power source 104, and detect the voltage of the primary power source 102 is within an acceptable range. Because in some examples the controller 108 is configured to prefer connecting the load 106 with the primary power source, the monitor switch 120 can operate to provide power from the primary power source to the controller voltage source 122 via the primary controller switch 116.

In a third scenario, the monitoring relay 114 can detect a presence of voltage of the primary power source 102, a lack of voltage of the secondary power source 104, and detect that the voltage of the primary power source 102 is outside of an acceptable range. Accordingly, the monitor switch 120 can operate to provide no power to the controller voltage source 122, as no acceptable power is available. In this third scenario, the controller 108 is unpowered at least until the voltage of the primary power source 102 returns to be within an acceptable range.

In a fourth scenario, the monitoring relay 114 can detect a presence of voltage of the primary power source 102, a presence of voltage of the secondary power source 104, and detect the voltage of the primary power source 102 is outside an acceptable range. Accordingly, the monitor switch 120 can operate to provide power from the secondary power source to the controller voltage source 122 via the secondary controller switch 118.

In a fifth scenario, the primary power source 102 and the secondary power source 104 are inactive and the monitoring relay 114 does not detect a voltage for either source. Accordingly, the monitor switch 120 can operate to provide no power to the controller voltage source 122, as no acceptable power is available.

In a sixth scenario, the monitoring relay 114 can detect a lack of voltage of the primary power source 102 and a presence of voltage of the secondary power source 104. Accordingly, the monitor switch 120 can operate to provide power from the secondary power source to the controller voltage source 122 via the secondary controller switch 116.

As one having ordinary skill in the art will appreciate, the system 100 can transition between any of the example scenarios outlined above and can go through multiple scenarios. For instance, in one example operation, the system 100 can transition from the first scenario to the fifth scenario, to the sixth scenario, to the fourth scenario, to the second scenario, and finally back to the first scenario. In some examples, such scenarios and results occur using pure relay logic along with robust equipment without the use of battery backups.

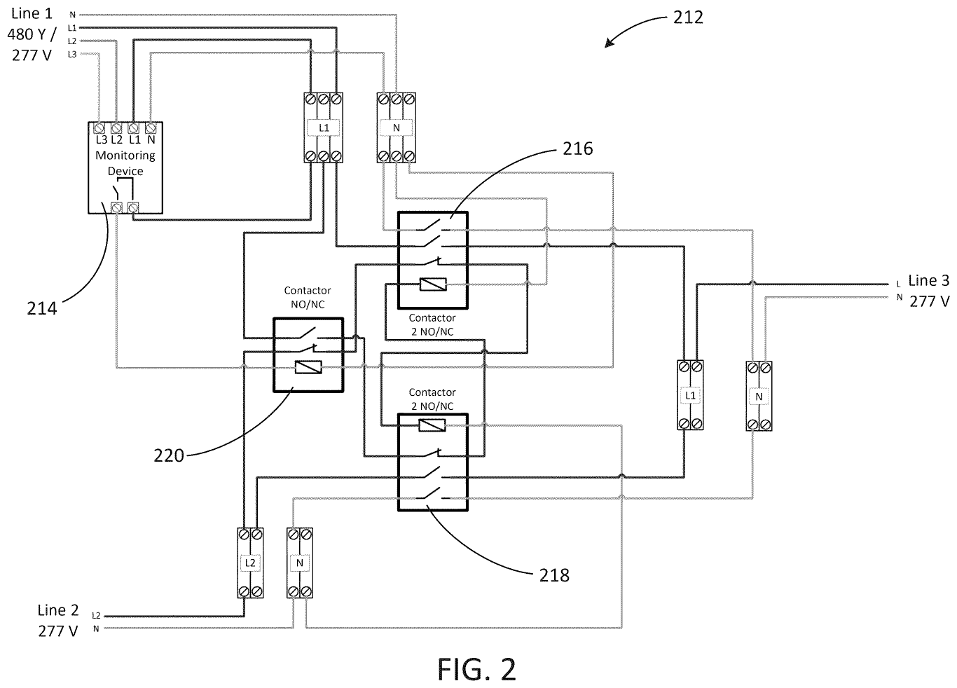

FIG. 2 is a schematic view of an example switching network 212 with monitoring relay 214 according to an aspect of the present disclosure. The switching network 212 has a line 1 input and a line 2 input that each comprise a hot wire and a neutral wire. The switching network 212 also includes a line 3 output, which is an output of the switching network 212 and includes a hot wire and a neutral wire.

In some examples, the line 1 input corresponds to an input from a primary power source, the line 2 input corresponds to an input from a secondary power source, and the line 3 output is used to power a controller (e.g., to provide power to controller voltage source 122 to power controller 108) that controls a transfer switch, as is described elsewhere herein. In the illustrated example, the voltage is 277 V RMS, though other voltages, both single- and multi-phase AC, are contemplated. The switching network 212 further comprises three switches (e.g., relays): a monitoring relay switch (also “monitor switch”) 220, a line 1 switch 216, and a line 2 switch 218.

The monitor switch 220 has inputs of the line 1 input, the line 2 input, and the monitoring relay 214 and further has outputs of the line 1 switch 216 and the line 2 switch 218. In the illustrated configuration, the monitoring relay 214 only monitors the voltage of line 1, though in some examples, the monitoring relay 214 monitors the voltage of line 2, either in addition to, or instead of, monitoring the voltage of line 1. The input of the monitoring relay 214 to the monitor switch 220 is used to determine whether the monitor switch 220 should enable connection (e.g., energize the relay) to the line 1 input. As discussed elsewhere herein, the monitoring relay 214 can monitor a voltage and determine if the voltage is within an acceptable range. For example, if the voltage of line 1 is within an acceptable range, the monitor switch 220 will energize and connect the line 1 input to the monitor switch's output (e.g., the line 2 switch 218 and the line 1 switch 216 through the line 2 switch 218). When the monitor switch 220 switches (e.g., is energized), it connects one of the line 1 input or the line 2 input to the outputs while also disconnecting the other of the one of the line 1 input or the line 2 input. Accordingly, only one of the line 1 input or the line 2 input will be connected to the monitor switch's outputs at a time.

The switching network 212 also includes the line 1 switch 216, which has inputs of the line 1 input, the monitor switch 220, and the line 2 switch 218, and has the output of the line 3 output. Similarly, the switching network 212 includes the line 2 switch 218, which has inputs of the line 2 input, the monitor switch 220, and the line 1 switch 216, and has the output of the line 3 output. The line 1 switch 216 and the line 2 switch 218 interact with each other and with the monitor switch 220 to conditionally connect the line 1 input or the line 2 input to the line 3 output. In some examples, the line 1 input can be preferentially connected to the line 3 output with the line 2 input being connected to the line 3 output when the line 1 input drops out (e.g., is no longer powered). The switching between line 1 and line 2 can happen passively/automatically as the line 2 switch 218 can include a normally-closed (NC) switch (e.g., relay) that is held open by power carried by the line 1 input (e.g., from the input from the line 1 switch 216). Thus, when power on line 1 drops out, the line 2 switch 218 closes automatically and connects the line 2 input to the line 3 output. In a similar manner, the line 1 switch 216 can include a normally open switch (NO) that is held closed by power carried by the line 1 input (e.g., from the input from the line 2 switch 218). Thus, when power on line 1 drops out, the line 1 switch 216 opens automatically and disconnects the line 1 input from the line 3 output.

In the illustrated embodiment of FIG. 2, line 1 power is a three-phase input. In some embodiments, if the line 1 input is active (e.g., able to provide power), the monitoring relay 214 can determine if the voltage of the three phase inputs are within an acceptable range. If the voltage is within an acceptable range, then the monitoring relay 214 can energize the monitor switch 220, which will cause the line 1 switch 216 and the line 2 switch 218 to change states and connect the line 1 input to the line 3 output.

As one having ordinary skill in the art will appreciate, the switching network 212 of FIG. 2 is merely one example of a switching network, and this disclosure is not limited to the illustrated example switching network 212. For instance, while the line 1 switch 216 can include a NO switch and the line 2 switch 218 can include a NC switch, in some examples, the line 1 switch 216 includes a NC switch and the line 2 switch 218 includes a NO switch. Further, other configurations of switches and wiring that enable the automatic (e.g., passive) transfer of power between a line 1 input and a line 2 input to provide power to the line 3 output are contemplated.

In some embodiments, when the controller begins losing power, for example, due to an outage of a primary power source (e.g., a utility outage) or a disconnection of the primary power source due to otherwise inadequate power (e.g., as determined by a monitoring relay 114, 214), the controller 108 does not immediately cease functioning. For instance, in some embodiments, the controller 108 either connects to, or can itself include, one or more components that are configured to temporarily store energy, and to discharge such stored energy, for example, following a loss of power from the primary or secondary power sources. For example, as described with respect to FIG. 1B, in some embodiments, the controller 108 is configured to receive power from a controller power supply circuit 107, which can include one or more transformers and/or other components (e.g., one or more capacitors) that can be configured to discharge stored energy over some period of time after power is lost. In some cases, the controller power supply circuit does not include a battery to continue providing power to the controller; in such cases, temporary power provided by discharging stored energy (e.g., residual power) from one or more energy storage components (e.g., one or more transformers) can be available for the controller 108 to use after power from the primary power source is lost.

The residual power available to the controller can provide a temporary operating window for the controller 108 to operate by using the residual power after a primary power source 102 becomes unavailable. In an example embodiment, the controller power supply circuit 107 is powered at 480 volts from the primary power source 102 during typical operation and outputs 24 VDC to the controller 108. In some examples, the controller power supply circuit 107 can provide a sufficient voltage to operate the controller 108 (e.g., 24 VDC) as long as an input voltage is approximately equal to or greater than 100 volts (e.g., at an input winding of a transformer), although this particular voltage is provided for illustrative purposes only. If power from the primary power source 102 is lost, then the controller 108 can be configured to operate during the time it takes the applied voltage (e.g., in a winding of a transformer) to discharge from the 480 volts to the 100 volts, after which the controller 108 is no longer able to operate until the controller power supply circuit 107 receives power, e.g., from the secondary power source 104.

As described elsewhere herein, an interlocking configuration can ensure that if the primary power source 102 is able to again provide power after it had dropped out (e.g., a restoration of power from the primary power source 102), then the load 106 will be protected from being simultaneously connected to both the primary power source 102 and the secondary power source 104. Additionally, in some embodiments, one or more temporary energy storing elements (e.g., in the controller power supply circuit 107) can provide enough power to the controller 108 to open the set of circuit breakers that connect the load 106 to the primary power source 102 when power from the primary power source 102 is lost. Disconnecting the primary power source from the load can prevent undesirable issues with the failing primary power source 102 from affecting the load 106, such as utility transience or poor power quality, for example, when power at the primary power source 102 (e.g., a utility) is restored. In some cases, the controller, powered by residual power from the one or more temporary energy storing elements after power from the primary power source 102 is lost, does not close the set of circuit breakers to connect the load 106 to the secondary power source 104, but instead, controls circuit breakers to connect the load 106 to the secondary power source 104 after the controller is powered by the secondary power source.

Accordingly, in some examples, if power from the primary power source 102 is lost, then the controller 108, using residual power as elements of a power supply of the controller 108 discharge, disconnects the primary power source 102 from the load 106 by opening primary breaker(s) 132. Once the controller 108 loses power to the point of no longer operating, it ceases holding open the normally-closed contact (e.g., contact 130), causing the secondary power source 104 to start up. The lost power from primary power source 102 can also cause the switching network 112 of the controller power supply circuit 107 to connect the secondary power source to the controller voltage source 122 (e.g., via secondary controller switch 118) so that as the secondary power source starts up and outputs power, the controller 108 receives power from the secondary power source via the controller power supply circuit.

In some examples, the controller 108 can detect that the power from the primary source 102 to the controller is lost (e.g., due to a utility failure). The controller 108 can be configured to, while temporarily operating on residual power, stop providing power to hold open the normally-closed contact (e.g., contact 130) earlier than the normally-closed contact would close if the controller 108 were allowed to continue holding contact 130 open until controller 108 no longer has sufficient power to hold open the contact. In some such examples, the controller 108 can decide to stop powering the normally-closed contact 130; as a result, the normally-closed contact closes and causes the secondary power source to begin to start up even before the controller 108 fully loses power. Once the controller 108 fully loses power, the normally-closed contact remains closed, since it is not powered or held open by the controller 108. In some cases, maintaining the normally-closed contact in the closed state enables the secondary power source to continue to start up and/or operate. The above-described operation may be desirable, for example, in situations where starting up the secondary power source somewhat sooner can reduce the amount of time that power is unavailable from both the primary and secondary power sources.

In some examples, the one or more temporary energy storing elements can provide power to the controller 108 for enough time for the controller to be powered by the secondary power source 104. For instance, the one or more temporary energy storing elements can provide power to the controller 108 until the secondary power source 104, which can comprise a utility or other power source that does not require a startup period, powers the controller 108. In other examples, the one or more temporary energy storing elements can provide power to the controller 108 until a generator or generators of the secondary power source 104 are able to start and provide power to the controller 108. In still other examples, if the secondary power source 104 is always present, such as a second utility power source, the controller 108 can be automatically powered by the secondary power source after power from the primary power source is lost, and the controller 108 does not need to initiate a startup of the secondary power source.

As discussed above with respect to FIG. 1A, in some examples, if the controller 108 loses power, then a normally-closed contact 130 can close and initiate startup of a secondary power source in the form of a generator. As the controller 108 is connected to the activated secondary power source 104, the controller 108 can control the transfer switch 110 to connect the load 106 to the secondary power source 104.

Accordingly, in some embodiments, to enable proper control of the transfer switch 110, the controller 108 can be programmed to activate the transfer switch 110 to connect the load 106 to the secondary power source 104 upon the controller 108 being powered by the secondary power source 104. In some examples, the controller 108 receives electrical data that is used to determine whether to activate the transfer switch 110 upon the controller 108 receiving power from the secondary power source 104. For instance, in some examples, upon the controller being powered by the secondary power source 104, the controller 108 can use electrical data to determine the secondary power source 104 is powering the controller 108, and, in some embodiments, determine the secondary power source 104 is sufficiently active to provide power to the load 106. The controller 108 can be configured to, upon determining it is being powered by the secondary power source 104, control the transfer switch 110 to connect the secondary power source 104 to the load 106.

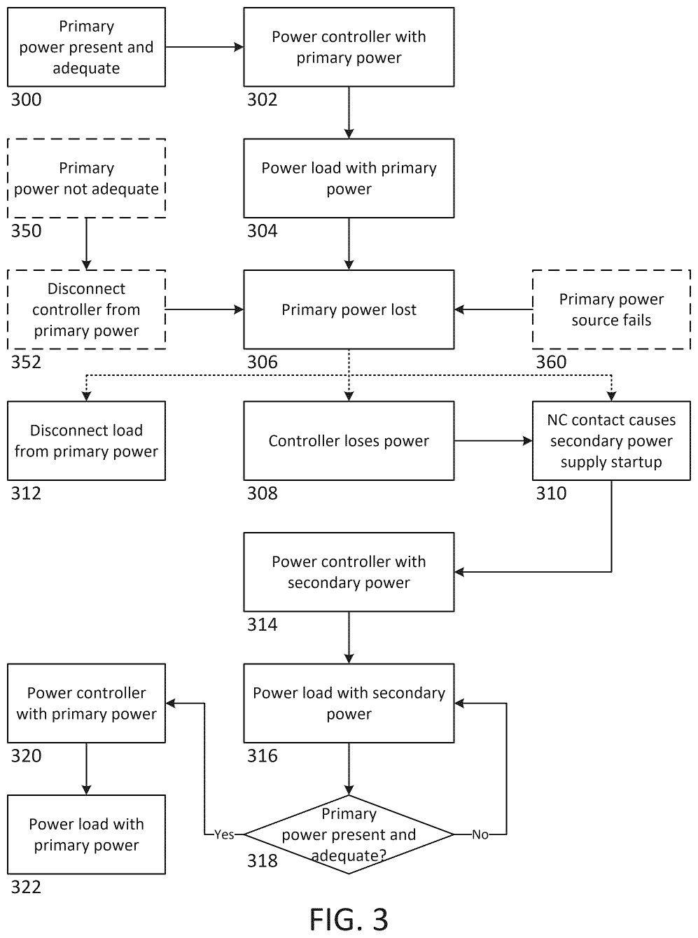

FIG. 3 shows an example process flow diagram of system operation controlling power distribution to the controller and to a load. In the illustrated example, the process begins with primary power being present and adequate (300) (e.g., power from primary power source 102 being present and determined adequate at monitoring relay 114). As a result, the controller (e.g., 108) is powered with the primary power (302) (e.g., via primary controller switch 116 and controller voltage source 122). The powered controller can also be configured to power a load (e.g., 106) with the primary power (304) (e.g., via primary breaker(s) 132 controllable by the controller 108).

However, if primary power to the controller is lost (306), then the controller loses power (308). In some examples, this can be due to failure of the primary power source (360), such as a utility outage. Additionally or alternatively, as described elsewhere herein, in some examples, if power from the primary power source is considered inadequate (350) (e.g., as determined at a monitoring relay), then power to the controller from the primary power source can be intentionally disconnected (352) (e.g., by opening a primary controller switch).

As described elsewhere herein, in some embodiments, after losing primary power (e.g., due to failure of the primary power source such as a utility outage or an intentional disconnection of the primary power source from the controller) the controller can operate on residual power (e.g., via one or more transformers and/or other components of a controller voltage source 122) for a short time after power is lost. While operating on the residual power, the controller can disconnect the load from primary power (312) (e.g., by disconnecting primary breaker(s) 132). Additionally, as described elsewhere herein, when the controller loses power, it can cease powering a normally-closed contact (e.g., 130) such that the normally-closed contact causes a secondary power supply (e.g., 104) to start up (310). As described elsewhere herein, in some examples, operating on residual power, the controller can be configured to intentionally stop powering the normally-closed contact such that normally-closed contact closes and causes the secondary power supply to start up (310). Thus, in some embodiments, the closing of the normally-closed contact causing startup of the secondary power supply need not occur entirely after the controller fully loses power. In some such examples, the controller fully losing power prevents power from the controller to open the normally-closed switch so that the secondary power supply continues to start up and/or operate.

Once the secondary power supply has started up, the controller can be powered via the secondary power supply (314) (e.g., using secondary controller switch 118). The controller, powered by secondary power, can cause secondary power to be applied to the load (316) (e.g., via secondary breaker(s) 134). In some embodiments, the controller is configured to determine that it is receiving power from the secondary power source and control a transfer switch to provide secondary power to the load. Additionally or alternatively, in some examples, the controller can assess the power conditions (e.g., whether power is present and/or adequate at the primary and/or secondary power sources) and determine that powering the load via the secondary power source is appropriate.

Primary power can be monitored while the load continues to be powered via secondary power (e.g., at monitoring relay 114). Since the system is configured to favor primary power, in some examples, if primary power is determined to be present and adequate (318), then the controller can be changed to be powered via primary power (320) (e.g., via primary controller switch 116). In some cases, determining that primary power is present and adequate comprises determining that one or more parameters of the primary power source are adequate (e.g., has suffice voltage, power quality, etc.). In some cases, the primary power is only considered adequate if the power satisfies such one or more conditions for at least a predetermined period of time (e.g., has sufficient voltage and power quality for at least 5 minutes, at least 10 minutes, or some other minimum duration).

After the controller is powered via primary power (320), the controller can operate to power the load via primary power (e.g., via opening secondary breaker(s) 134 and closing primary breaker(s) 132). In some embodiments, the controller is configured to determine that it is receiving power from the primary power source and control a transfer switch to provide primary power to the load. Additionally or alternatively, in some examples, the controller can assess the power conditions (e.g., whether power is present and/or adequate at the primary and/or secondary power sources) and determine that powering the load via the primary power source is appropriate.

Once the load transitions back to primary power, the process can carry on operating as in 300, 302, and 304, where primary power is present and adequate, the controller is powered via primary power, and the load is powered via primary power, and the process can run continuously.

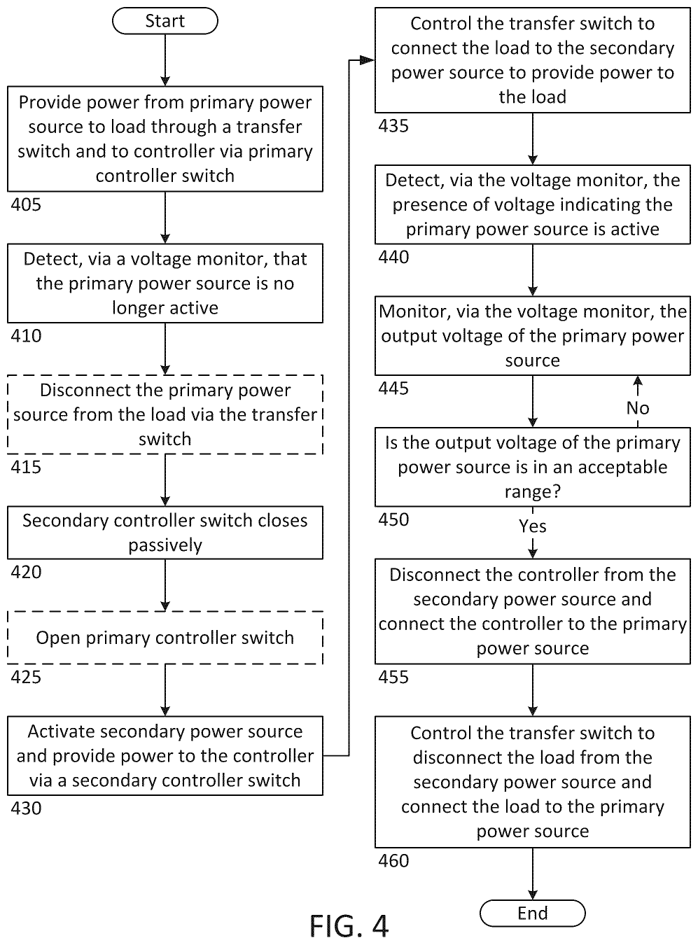

FIG. 4 is a flow chart of an example operation of an automatic transfer switch and power supply system according to an aspect of the present disclosure. The flow starts at 405 in an initial condition where the primary power source provides power to a load through a transfer switch and provides power to a controller that controls the transfer switch through a primary controller switch. In this initial condition, a secondary controller switch, which is configured to be normally closed, is held open by the power provided by the primary power source. Next, at 410, a monitoring relay can detect that the primary power source is no longer active (e.g., cannot provide power). In some examples, such as at 415, the controller can subsequently disconnect the primary power source from the load via the transfer switch. As noted elsewhere herein, in some examples, the controller can disconnect the primary power source from the load via the transfer switch while operating on residual power as a power supply for the controller discharges after the loss of the primary power source.

Once the primary power source is no longer active, the normally-closed secondary controller switch passively closes at 420 due to the loss of power from the primary power source and connects the controller to the secondary power source. In some examples, such as at 425, when the primary power source is no longer active, the primary controller switch is disconnected from the controller (e.g., via the secondary controller switch being linked with the primary controller switch). Next, at 430, the secondary power source can activate (e.g., auto-start due to secondary controller switch closing) and provide power to the controller via the secondary controller switch. At 435, the controller can then connect the load to the secondary power source via the transfer switch for the secondary power source to provide power to the load. In some examples, the controller waits to connect the load to the secondary power source until a monitoring relay determines a voltage of the secondary power source is within an acceptable range.

The flow can further continue when the primary power source becomes active again. At 440, the monitoring relay can detect a presence of voltage of the primary power source indicating the primary power source is active. At 445, the monitoring relay can also monitor the voltage of the primary power source to determine if it is in an acceptable range. The controller can determine if the voltage is, or is not, within an acceptable range at 450. If the voltage is not in an acceptable range, a monitor switch connected to the monitoring relay does not activate, the primary power source is not connected to the controller, and the controller does not activate the transfer switch to connect the load to the primary power source. Accordingly, the monitoring relay will continue to monitor the voltage, as in 445. If, however, the voltage of the primary power source is acceptable, then the monitor switch can activate. In some examples, determining if an output voltage is in an acceptable range comprises determining if such an output voltage meets one or more predetermined conditions (e.g., voltage, power quality, etc.) for at least a predetermined minimum amount of time to ensure that the power at the primary power source is stable. In some such examples, such an analysis can be performed in ways similar to those discussed elsewhere herein.

Activation of the monitor switch can cause the primary controller switch to connect the controller to the primary power source and can cause the secondary controller switch to disconnect the controller from the secondary power source, as in 455. Next, at 460, the controller can control the transfer switch to disconnect the load from the secondary power source and connect the load to the primary power source. In some examples, the controller can control the transfer switch to connect the load to the primary power source before the controller is powered by the primary power source (e.g., via the switching of the primary controller switch and the secondary controller switch).

The example flow of FIG. 4 can be typical of a loss of primary power (e.g., a utility), an activation of secondary power (e.g., a generator), and a subsequent re-connection of primary power when the primary power is active again.

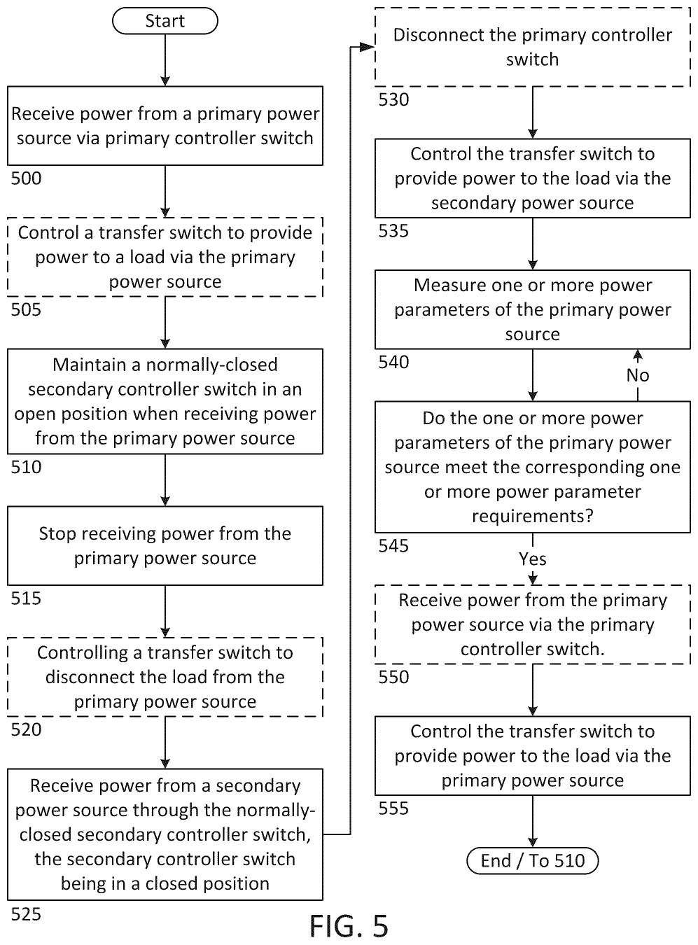

FIG. 5 is a flow chart of an example operation of an automatic transfer switch and power supply according to an aspect of the present disclosure. Flow starts at 500 by receiving power from a primary power source via a primary controller switch. In some examples, flow includes 505, controlling a transfer switch to provide power to a load via the primary power source, though in some examples, the transfer switch is already connected to provide power to the load via the primary power switch. Flow continues at 510 with maintaining a normally-closed secondary controller switch in an open position when receiving power from the primary power source. Flow further continues at 515 with stopping receiving power from the primary power source. Flow can optionally include at 520 controlling a transfer switch to disconnect the load from the primary power source. Flow then continues at 525 with receiving power from a secondary power source through the normally-closed secondary controller switch. Flow can optionally include at 530 disconnecting the primary controller switch. In some cases, the primary controller switch is disconnected upon stopping receiving power from the primary power source at 515.

Further, flow continues at 535 with controlling the transfer switch to connect the load to the secondary power source. Flow further continues at 540 with measuring one or more power parameters of the primary power source and determining, at 545, if one or more power parameters of the primary power source meet a corresponding one or more power parameter requirements (e.g., thresholds, ranges, and in some cases, for at least a threshold amount of time).

If the one (or more) power parameter(s) does (do) not meet the corresponding power parameter requirement(s), then flow can repeat 540 and 545. If the one (or more) power parameter(s) meet(s) the corresponding power parameter requirement(s), then flow can continue directly to 555 with controlling the transfer switch to provide power to the load via the primary power source. Optionally, in some examples, if the one (or more) power parameter(s) meet(s) the corresponding power parameter requirement(s), then flow can continue first with receiving power from the primary power source via the primary controller switch. In some such examples, flow can also include stop receiving power from the secondary power source. After 555, flow can end or can return to 510 for subsequent operation.

As a person having ordinary skill in the art will appreciate, one or more of the steps illustrated in the flows of FIG. 4 and FIG. 5 may be optional, including those not specified as optional. Further, one or more of the steps can be performed in an order different than the illustrated order and one or more of the steps can be performed at substantially the same time as another one or more of the steps. Additional steps not specifically illustrated can also be included in the example flows of FIG. 4 and FIG. 5.

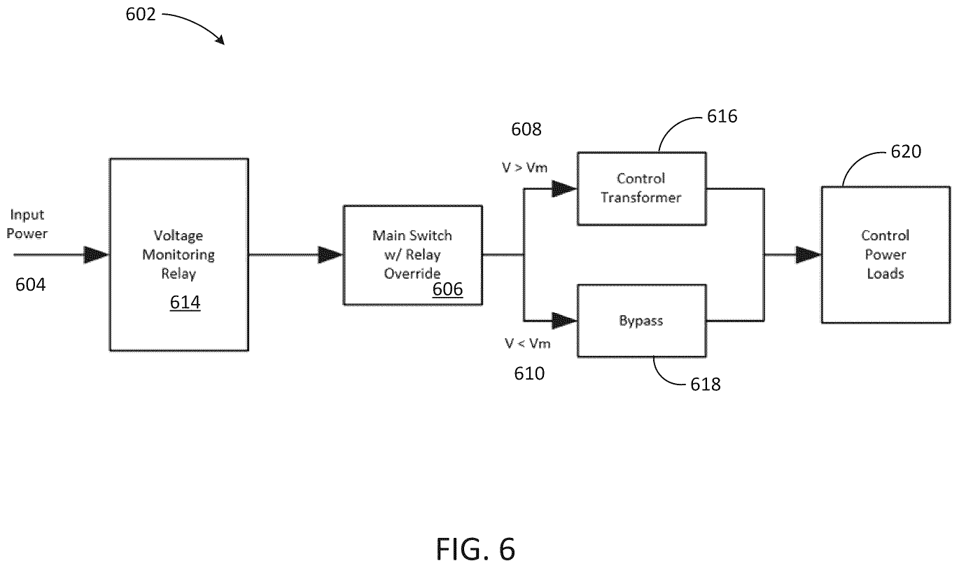

FIG. 6 is a schematic diagram showing an exemplary voltage override feature or sub-system for an automatic transfer switch that can provide the ability to handle variations in characteristics of an input power source (e.g., either primary or secondary power sources). In some examples, such a feature can help make a power distribution system more robust by making the automatic transfer switch unit “agnostic” to input voltage, for example. In some embodiments, it may be desirable to have the system determine or detect certain characteristics of a local power source and make a decision and/or an adjustment to account for the particular characteristics of the local power source. A scenario may arise in a temporary or portable local power situation (e.g., providing electrical power to an outdoor concert or event), for example, where the characteristics of the local power sources (both the “primary” and/or the “secondary” power sources in some situations) may not necessarily be known. If an operator were to manually connect one or more such local power sources (e.g., as the primary and/or secondary power source) to an automatic transfer switch, it could result in damage to the transfer switch and to the control and/or power circuitry associated with the transfer switch. In some embodiments, this can involve a feature in which the system is configured to adapt or adjust to the local power source characteristics. For example, in some embodiments, the system can detect or sense whether the local power source is 3-phase power at 600V, or 480V, or 208V, etc., or is at some other less standard voltage level, and can be configured to make an appropriate adjustment to account for and/or protect the control circuitry based on the detected local power source characteristics (voltage, in this case). In some cases, this adjustment for local power source characteristics can prevent a user from making an error that could possibly damage the transfer switch control circuitry. For example, if a user manually selected (e.g., via a switch) 208V as the operating voltage for the local power source (e.g., based on erroneous information provided, or carelessness, etc.), while the actual local power source voltage was 600V, the control circuitry associated with the transfer switch could be damaged or rendered inoperable. A voltage override feature as described below with reference to FIG. 6 can address and/or avoid the potential problems described above.

In FIG. 6, an exemplary voltage override system (or sub-system) 602 is depicted according to an aspect of this disclosure. Voltage override system 602 shows an input power source 604, which can come from a local power source, as an input to a voltage monitoring relay 614 of the voltage override system 602, as shown. The voltage monitoring relay 614 may function generally as described above with respect to the functioning of monitoring relay 114 of FIG. 1B, and/or monitoring relay 214 of FIG. 2, for example. In some cases, monitoring relay 614 can monitor one or more parameters or characteristics of input power source 604, such as one or more voltages (e.g., one or more true root mean square, TRMS, voltages), frequency information, and/or phase balance as possible examples. In some cases, the monitoring relay 614 can also determine whether a voltage, frequency, or phase balance is within an acceptable range. A switch 606 is configured to receive the input power 604 from the voltage monitoring relay 614. Switch 606 can be configured to make a determination or decision regarding a characteristic of the input power 604 (e.g., as determined by monitoring relay 614). In the example depicted in FIG. 6, a determination is made regarding the voltage level of the input power 604. For example, in FIG. 6, a determination can be made as to whether the voltage level of the input power 604 is greater than or less than a defined threshold level, in this case, Vₘ. For example, if the voltage level of the input power 604 is greater than Vₘ, as shown at 608, a control transformer 616 can be employed to reduce the voltage to a level that is appropriate to send to control circuitry 620 for controlling operation of the automatic transfer switch. If instead, the voltage level of the input power 604 is less than Vₘ, as shown at 610, a bypass 618 can be employed to direct or couple the power signal to control circuitry 620 without changing the voltage level, for example.

In the example depicted in FIG. 6, a single “cutoff” voltage, Vₘ, is employed, although this is for simplicity of illustration only. It is contemplated that a more complex determination of voltage levels could similarly be made to distinguish between some relatively common three-phase voltage levels (e.g., 600V, 480V, and 208V), for example, with multiple threshold voltage levels or cutoffs, with only a slight variation from the exemplary arrangement shown in FIG. 6. Likewise, other parameters such as frequency and/or phase balance may involve a similar determination being made (e.g., by monitoring relay 614 and/or switch 606), and corresponding adjustments made by override system 602 to account for differences in such variables while continuing to provide an appropriate power signal to the control circuitry of the automatic transfer switch.

Various embodiments of systems and components described herein can be implemented using relay logic and without requiring battery solutions. For example, in some embodiments, a controller (e.g., 108) comprises one or more processors or other components configured to be programmed to perform one or more functions. The controller can include or otherwise be in communication with a memory comprising instructions for causing one or more programmable processors to carry out instructions stored in the memory. In some examples, systems can include a user interface by which a user can input various parameters to guide operation of the controller, for example, defining one or more power parameters that define suitable primary power before changing to secondary power and/or changing back from secondary power to primary power. Various examples are possible. The controller can be configured to, when active, control operation of one or more circuit breakers to provide electrical connection between primary or secondary power and a load. Relays, switches, or other appropriate devices can be used to automatically, and without backup battery power, turn on a secondary power source (e.g., a generator) in the event of a primary power source (e.g., utility) failure and use the secondary power source to power the controller for subsequent control of the circuit breakers. This can form a robust automatic transfer switch suitable for high current applications (e.g., due to using circuit breakers to control power distribution) and without requiring a battery backup, which may otherwise require maintenance and/or limitations on suitable operating environments.

Various examples have been described with reference to certain disclosed embodiments. The embodiments are presented for purposes of illustration and not limitation. One skilled in the art will appreciate that various changes, adaptations, and modifications can be made without departing from the scope of the invention.

What is claimed is:

1. A power distribution system for automatically switching between a primary electrical power source and a secondary electrical power source to power an electrical load, the power distribution system comprising:
a primary electrical power source;
a secondary electrical power source, the secondary electrical power source comprising a normally-closed contact configured to, when closed, enable the secondary electrical power source to provide electrical power;
an electrical load;
a transfer switch connected to the primary electrical power source, the secondary electrical power source, and the electrical load, the transfer switch configured to electrically connect the electrical load to either the primary electrical power source or the secondary electrical power source;
a controller in electric communication with the transfer switch and configured to control the transfer switch in order to control whether electrical power is directed to the electrical load from the primary electrical power source or the secondary electrical power source; and
a controller power supply circuit in communication with the primary electrical power source, the secondary electrical power source, and the controller, the controller power supply circuit configured to provide electrical power to the controller using electrical power from at least one of the primary electrical power source and the secondary electrical power source;
wherein the controller and the controller power supply circuit are configured such that:
if electrical power from the primary electrical power source is available, then:
the controller power supply circuit powers the controller using electrical power from the primary electrical power source;
the controller provides electrical power to the secondary electrical power source to hold open the normally-closed contact so that the secondary electrical power source does not provide power to the electrical load; and
the controller controls the transfer switch to provide electrical power to the electrical load from the primary electrical power source.

2. The power distribution system of claim 1, wherein the transfer switch comprises a plurality of circuit breakers controllable by the controller.

3. The power distribution system of claim 2, wherein the plurality of circuit breakers comprises at least one primary circuit breaker configured to control an electrical connection between the primary electrical power source and the electrical load and at least one secondary circuit breaker configured to control an electrical connection between the secondary electrical power source and the electrical load.

4. The power distribution system of claim 2, wherein the plurality of circuit breakers is rated up to an electrical current of at least 5000 A.

5. The power distribution system of claim 1, wherein the controller power supply circuit comprises:
a primary controller switch coupled between the primary electrical power source and the controller; and
a secondary controller switch coupled between the secondary electrical power source and the controller, the secondary controller switch configured to be a normally-closed switch;
wherein, when the controller receives power from the primary electrical power source through the primary controller switch, the normally-closed secondary controller switch is maintained in an open position; and
wherein, when the controller does not receive power from the primary electrical power source through the primary controller switch, the normally-closed secondary controller switch closes automatically so that the controller receives power from the secondary electrical power source through the closed secondary controller switch.

6. The system of embodiment 1, wherein the controller is configured to, upon losing power from the primary electrical power source, control the transfer switch to disconnect the primary electrical power source from the electrical load.

7. The power distribution system of claim 1, wherein the normally-closed contact of the secondary electrical power source is configured to cause the secondary electrical power source to start up when the normally-closed contact is closed.

8. A switching system for automatically switching between a primary electrical power source and a secondary electrical power source to power an electrical load, comprising:
a transfer switch connected to the primary electrical power source, the secondary electrical power source, and the electrical load, the transfer switch configured to electrically connect the electrical load to either the primary electrical power source or the secondary electrical power source;
a controller in communication with the transfer switch and configured to control the transfer switch in order to control whether electrical power is directed to the electrical load from the primary electrical power source or the secondary electrical power source; and
a controller power supply circuit in communication with the primary electrical power source, the secondary electrical power source, and the controller, the controller power supply circuit configured to provide electrical power to the controller using power from at least one of the primary electrical power source and secondary electrical power source;
wherein the controller and the controller power supply circuit are configured such that:
if electrical power from the primary electrical power source is available, then:
the controller power supply circuit powers the controller using electrical power from the primary electrical power source;
the controller provides power to the secondary electrical power source to hold open a normally-closed contact associated with the secondary electrical power source so that the secondary electrical power source does not operate; and
the controller controls the transfer switch to provide electrical power to the electrical load from the primary electrical power source.

9. The switching system of claim 8, wherein the transfer switch comprises a plurality of circuit breakers controllable by the controller.

10. The switching system of claim 9, wherein the plurality of circuit breakers is rated up to an electrical current of at least 5000 A.

11. The switching system of claim 8, wherein the controller power supply circuit comprises:
a primary controller switch coupled between the primary electrical power source and the controller; and
a secondary controller switch coupled between the secondary electrical power source and the controller; the secondary controller switch configured to be a normally-closed switch;
and wherein the controller receives electrical power from the primary electrical power source through the primary controller switch and maintains the normally-closed secondary controller switch in an open position; and
when the controller no longer receives electrical power from the primary electrical power source, the normally-closed secondary controller switch closes automatically so that the controller receives electrical power from the secondary electrical power source through the closed secondary controller switch.

12. The switching system of claim 8, wherein the controller is configured to, upon losing electrical power from the primary electrical power source, control the transfer switch to disconnect the primary electrical power source from the electrical load.

13. The switching system of claim 8, wherein the normally-closed contact of the secondary electrical power source is configured to cause the secondary electrical power source to start up when the normally-closed contact is closed.

14. A method comprising:
providing electrical power to a controller via a primary electrical power source through a primary controller switch;
providing electrical power to an electrical load via the primary electrical power source through a transfer switch;
maintaining a normally-closed secondary controller switch in an open position when electrical power is provided to the controller via the primary electrical power source; and
upon the primary electrical power source no longer able to provide electrical power to the controller:
providing power to the controller via a secondary electrical power source through the secondary controller switch, the secondary controller switch being in a closed position; and
controlling the transfer switch to provide electrical power to the electrical load via the secondary electrical power source.

15. The method of claim 14, further comprising, upon the primary electrical power source no longer being able to provide power to the controller, closing a normally-closed contact to enable startup and operation of the secondary electrical power source.

16. The method of claim 14, further comprising, upon the primary electrical power source no longer being able to provide electrical power to the controller, disconnecting the electrical load from the primary electrical power source.

17. The method of embodiment 16, wherein disconnecting the electrical load from the primary electrical power source is performed before providing electrical power to the controller via a secondary electrical power source through the secondary controller switch.

18. A method comprising:
receiving electrical power from a primary electrical power source through a primary controller switch;
controlling a transfer switch to provide power to an electrical load via the primary electrical power source;
maintaining a normally-closed contact associated with a secondary electrical power source in an open position to prevent operation of the secondary electrical power source;
maintaining a normally-closed secondary controller switch in an open position when receiving power from the primary electrical power source;
upon ceasing to receive electrical power from the primary electrical power source:
stop holding the normally-closed secondary controller switch in the open position;
stop holding the normally-closed contact associated with the secondary electrical power source in the open position so that the secondary electrical power source operates;
receiving electrical power from the operating secondary electrical power source through the normally-closed secondary controller switch, the normally-closed secondary controller switch being in a closed position; and
controlling the transfer switch to provide electrical power to the electrical load via the secondary electrical power source.

19. The switching system of claim 11, wherein the controller power supply circuit further comprises:
a monitoring relay, the monitoring relay configured to sense at least one characteristic of the primary electrical power source;
an override switch coupled to the monitoring relay, the override switch configured to make a determination based on the at least one characteristic of the primary electrical power source; and
at least one transformer,
wherein the override switch is configured to couple a power signal from the primary electrical power source to the at least one transformer if the at least one characteristic of the primary electrical power source exceeds a first threshold, and
wherein the override switch is configured to allow the power signal from the primary electrical power source to bypass the at least one transformer if the at least one characteristic of the primary electrical power source is below the first threshold.
